(19) United States
(12) Patent Application Publication
(10) Pub. No.: US 2015/0317516 A1
(43) Pub. Date: Nov. 5, 2015

(54) METHOD AND SYSTEM FOR REMOTE CONTROLLING

(71) Applicant: INUITIVE LTD., RaAnana (IL)

(72) Inventors: Ziv TSOREF, Tel-Aviv (IL); Zohar SHIMELMITZ, Tel-Aviv (IL)

(21) Appl. No.: 14/649,218

(22) PCT Filed: Dec. 4, 2013
(86) PCT No.: PCT/IL2013/050997

§ 371 Date: Jun. 3, 2015

Related U.S. Application Data
(60) Provisional application No. 61/733,447, filed on Dec. 5, 2012.

(51) Int. Cl. G06K 9/00; G06F 3/01

(52) U.S. Cl. CPC G06K 9/00355; G06F 3/017

(57) ABSTRACT

A method of remote controlling is disclosed. The method comprises: capturing image data from a scene at the vicinity of an appliance, processing the image data to recognize at least one gesture of an individual present in the scene, and changing a state of the appliance based on the at least one recognized gesture.

### RELATED APPLICATION

This application claims the benefit of priority of U.S. Provisional Patent Application No. 61/733,447, filed on Dec. 5, 2012 are incorporated by reference as if fully set forth herein.

### FIELD AND BACKGROUND OF THE INVENTION

The present invention, in some embodiments thereof, relates to remote controlling and, more particularly, but not exclusively, to a method and system for remotely changing the state of an appliance by gesture recognition.

With the increasing development of social automation and social diversification, numerous industrial devices and household appliances have been generally operated by their unique remote-controllers. If a user employs the remote-controller, the user need not go to an installation place of a receiver capable of receiving a desired signal at a remote site, and need not directly operate the receiver at the installation place, such that the user can command operations of the receiver at a remote site. In other words, the remote-controller has been widely used in all the receivers (e.g., television receivers, audio-players, video-players, air-conditioners, etc.)

The aforementioned remote-controller and its associated receiver have been supplied to a user as a single set when the user purchases the receiver. Therefore, the user owns a variety of remote-controllers as many as the number of receivers.

To minimize the number of individual remote control units a user requires, universal remote control units have been developed. Accordingly, infrared remote control units for controlling various functions of television receivers, video-players, and auxiliary electronic equipment have become quite widespread in recent years. U.S. Pat. Nos. 5,255,313 and 5.552,917, for example, disclose universal remote control systems.

### SUMMARY OF THE INVENTION

According to an aspect of some embodiments of the present invention there is provided a method of remote controlling. The method comprises: using a gesture recognition system for capturing image data from a scene at the vicinity of an appliance and processing the image data to recognize at least one gesture of an individual present in the scene; and changing a state of the appliance based on the at least one recognized gesture.

According to some embodiments of the invention the method comprises determining presence or absence of the individual in the scene.

According to some embodiments of the invention the method comprises changing a power consumption level of the appliance based on the presence or absence.

According to some embodiments of the invention the method comprises changing a power consumption level of the gesture recognition system based on the presence or absence.

According to some embodiments of the invention the gesture recognition system comprises a plurality of pixilated sensors, and wherein the changing the power consumption level of the gesture recognition system comprises activating and deactivating pixels of the pixilated sensors responsively to the presence or absence.

According to some embodiments of the invention the method comprises identifying the individual, wherein the changing the state is conditional to positive identification of the individual.

According to some embodiments of the invention the method comprises selecting the appliance from a plurality of appliances based on the at least one recognized gesture.

According to some embodiments of the invention the appliance is selected based voice input from the individual.

According to some embodiments of the invention the method comprises selecting the appliance from a plurality of appliances based on an illumination pattern projected on the appliance.

According to some embodiments of the invention the recognizing the at least one gesture comprises analyzing a three-dimensional image of the individual.

According to some embodiments of the invention the recognizing the at least one gesture comprises analyzing an infrared image of the individual.

According to an aspect of some embodiments of the present invention there is provided a remote control system. The system comprises: a gesture recognition system configured for capturing image data from a scene at the vicinity of an appliance, and processing the image data to recognize at least one gesture of an individual present in the scene; and a controller configured for changing a state of the appliance based on the at least one recognized gesture.

According to some embodiments of the invention the gesture recognition system is configured for determining presence or absence of the individual in the scene.

According to some embodiments of the invention the gesture recognition system is configured for changing a power consumption level of the appliance based on the presence or absence.

According to some embodiments of the invention the gesture recognition system is configured for changing a power consumption level of the gesture recognition system based on the presence or absence.

According to some embodiments of the invention the gesture recognition system comprises a plurality of pixilated sensors, and being configured to activate and deactivate pixels of the pixilated sensors responsively to the presence or absence.

According to some embodiments of the invention the gesture recognition system is configured for identifying the individual, wherein the changing the state is conditional to positive identification of the individual.

According to some embodiments of the invention the gesture recognition system is configured for selecting the appliance from a plurality of appliances based on the at least one recognized gesture.

According to some embodiments of the invention the appliance is selected if a gaze of the individual is directed to the appliance for a predetermined time period.

According to some embodiments of the invention the gesture recognition system comprises a voice recognition system configured for selecting the appliance from a plurality of appliances based on voice input from the individual.

According to some embodiments of the invention the gesture recognition system is configured for selecting the appliance from a plurality of appliances based on an illumination pattern projected on the appliance.

According to some embodiments of the invention the gesture recognition system is configured for capturing and analyzing a three-dimensional image of the individual.

According to some embodiments of the invention the gesture recognition system is configured for capturing and analyzing an infrared image of the individual.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system.

In an exemplary embodiment of the invention, one or more tasks according to exemplary embodiments of method and/or system as described herein are performed by a data processor, such as a computing platform for executing a plurality of instructions.

Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a remote control system 10, according to some embodiments of the present invention;

FIG. 2 is a schematic illustration of an arrangement of the pixels on an imaging sensor according to some embodiments of the present invention;

FIG. 3 is a schematic illustration of an imaging sensor, according to some embodiments of the present invention;

FIG. 4 is a schematic illustration of the relation between an imaging sensor and several home appliances, according to some embodiments of the present invention; and

FIG. 5 is a schematic illustration describing an operation protocol of an imaging sensor, according to some embodiments of the present invention.

### DESCRIPTION OF SPECIFIC EMBODIMENTS OF THE INVENTION

The present invention, in some embodiments thereof, relates to remote controlling and, more particularly, but not exclusively, to a method and system for remotely changing the state of an appliance by gesture recognition.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present embodiments provide a method and system for remote controlling.

The technique of the present embodiments allows the user to operate one or more appliances in a comfortable manner, optionally and preferably without using any hand held remote control device that directly controls the operation of the appliance.

The system of the present embodiments can be used for controlling the operation of any indoor appliance, including, without limitation, a television system, a home cinema system, an audio player, an audio amplifier, a video player, a radio receiver, a personal computer, an air condition system, a kitchen appliance (e.g., a microwave oven, a convection ovens, a coffee machine, a mixer, a food processor), as well as outdoor appliances, such as, but not limited to, a vehicle and a lawn mower.

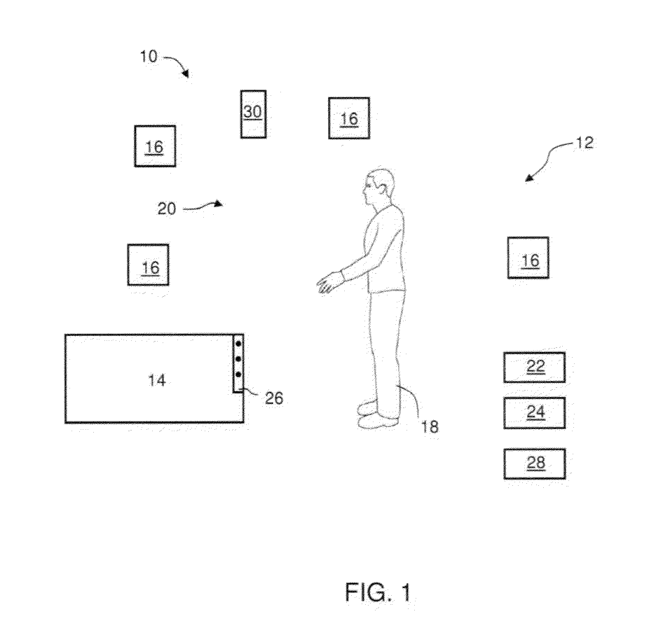

FIG. 1 is a schematic illustration of a remote control system 10, according to some embodiments of the present invention. Remote control system 10 comprises a gesture recognition system 12 deployed at the vicinity of an appliance 14 (for example, at the same enclosure (e.g., the interior of a room, an office, a hall, a vehicle, etc.) as appliance 14.

Gesture recognition system 12 optionally and preferably comprises one or more imaging devices 16 configured for capturing image data of a scene 20 at the vicinity of appliance 14.

As used herein “imager data” refers to a plurality of values that represent a two- or three-dimensional image, and that can therefore be used to reconstruct a two- or three-dimensional image.

Typically, the image data comprise values (e.g., grey-levels, intensities, color intensities, etc.), each corresponding to a picture-element (e.g., a pixel, a sub-pixel or a group of pixels) in the image. In some embodiments of the present invention, the image data also comprise range data as further detailed hereinbelow.

Shown in FIG. 1 are four imaging device 16. However, it is to be understood that it is not intended to limit the scope of the present invention to a system with four imaging devices and that configurations with less than four imaging devices or more than four imaging devices (e.g., 1, 2, 3, 5 or more imaging devices) are not excluded from the scope of the present invention. Herein, unless explicitly stated, a reference to imaging devices in the plural form should be construed as a reference to one or more imaging devices. Devices 16 are optionally and preferably deployed statically with respect to scene 20. For example, devices 16 can be mounted on walls, floor or ceiling (not shown) surrounding scene 20. In some embodiments of the present invention at least one device 16 is mounted on appliance 14. In some embodiments of the present invention system 12 comprises a single device 16 which is mounted on appliance 14.

Gesture recognition system 12 can also comprises an image processor 22 that receive the image data from devices 16 and processes the image data to recognize at least one gesture of an individual 18 present in scene 20. The communication between image processor 22 and devices 16 can be wireless or wired as desired.

Processor 22 can be provided as a separate unit to device 16 or it can be embedded in device 16. In some embodiments of the present invention system 12 comprises a single device 16 which is mounted on appliance 14 and which includes processor 22.

Processor 22 can be any man-made machine capable of executing an instruction set and/or performing calculations. Representative examples including, without limitation, a general purpose computer supplemented by dedicated software, general purpose microprocessor supplemented by dedicated software, general purpose microcontroller supplemented by dedicated software, general purpose graphics processor supplemented by dedicated software and/or a digital signal processor (DSP) supplemented by dedicated software. Data processor can also comprise dedicated circuitry (e.g., a printed circuit board) and/or a programmable electronic chip into which dedicated software is burned.

When a plurality of devices 16 is employed, the imaging devices optionally and preferably provide partially overlapping field-of-views of scene 20. The overlap between field-of-views allows processor 22 to combine the individual field-of-views. In some embodiments, the spacing between the imaging devices is selected to allow processor 22 to construct a three-dimensional reconstruction of individual 18.

As used herein “gesture,” refers to at least one of: a movement performed by individual 18 or a bodily part thereof, a pose configuration assumed by individual 18 or a bodily part thereof, and a change in a movement or pose of individual 18 or a bodily part thereof. The gesture is expressive of an interpretable piece of information, e.g., a control command. Typically, but not necessarily, a gesture comprises a posture of the hand.

Suitable techniques for the recognition of gestures are described, for example, in “Visionbased hand pose estimation: A review” by A. Erol et. al. Computer Vision and Image Understanding, 108 (2007) 52-53), the contents of which are hereby incorporated by reference.

System 10 further comprises a controller 24 that communicates with processor 22 and changes the state of appliance 14 based on the recognized gesture. System 10 can comprise a central controller that communicates with processor 22. Alternatively, one or more of devices 16 can include a processor and a controller and can be configured to communicate directly with appliance 14. Herein, reference to controller 24 encompasses both embodiments in which a central controller is employed, and embodiments in which the controller is part of device 16 (e.g., engages the same electronic chip with the image sensor of device 16). In some embodiments of the present invention system 12 comprises a single device 16 which is mounted on appliance 14 and which includes processor 22.

The change of state can include any user-initiated operation, including, without limitation, powering the appliance on or off, switching the appliance to a standby mode or active mode and changing the mode of operation of the appliance.

The mode of operation depends on the type of appliance. For example, in an appliance that includes an audio output (e.g., a music player system, a home cinema system, a television system), the change in operation mode can include varying the output audio level, in an appliance that includes a display, the change in operation mode can include varying one or the display properties (e.g., brightness, contrast), in an appliance that can receive data streams from multiple channels, the change in operation mode can include switching from one channel to the other, in an appliance that capture data (e.g., a controllable camera) the change in operation mode can include zooming in or out, in an appliance that provides lightning, the change in operation mode can include varying the light intensity or color, in an appliance that provides air-conditioning, the change in operation mode can include varying the target temperature and/or circulation level.

It is expected that during the life of a patent maturing from this application many relevant types of appliances will be developed and the scope of the term “operation mode of an appliance” is intended to include all such new technologies a priori.

Thus, controller 24 effectively controls appliance 14 responsively to gestures made by individual 18 without the need of a hand-held remote control device. The type of change induced by controller 24 to appliance 14 depends on the gestures made by individual 18. In various exemplary embodiments of the invention system 12 is configured to access a database of gestures containing a plurality of database gestures, and a respective plurality of commands to be transmitted to appliance 14. In operation, system 12 recognize the gesture made by individual 18, accesses the database and compares the recognized gesture with the database gestures. Once a match is found between the recognized gesture and a particular database gesture, the corresponding command is retrieved from the database. Controller 24 then signals appliance 14 to change its state according to the retrieved command.

The database of gestures can be prepared in advance, for example, by capturing images of a volunteer performing a set of gestures, attributing a command to each captured image, and storing the captured images and attributed commands in a memory medium (not shown). The database gestures, optionally and preferably, resemble the movements and/or poses that one would have performed had he or she had to operate the appliance manually. For example, a database gesture that is attributed to the operation of switching on a lighting system can be an index finger pointing and/or moving upwards, a database gesture that is attributed to the operation of switching off a lighting system can be an index finger pointing and/or moving downwards, a database gesture that is attributed to the operation of increasing the level of some property (e.g., audio level, lighting intensity, target temperature, display brightness) can be a partially open fist rotating clockwise, and a database gesture that is attributed to the operation of decreasing the level of some property can be a partially open fist rotating anticlockwise. Other gestures are not excluded from the scope of the present invention.

It is to be understood that it is not necessary for the gesture to include motion or pose of the hands, and that any other gesture recognizable by system 12 can be employed. Representative examples of gestures other than hand-gestures include, without limitation, head gestures (motion and/or pose), gaze gestures (change of gaze direction, fixed gaze for a time period above a predetermined threshold), and whole body gesture (bending, rotation).

As used herein, “gaze direction” refers to the direction of a predetermined identifiable point or a predetermined set of identifiable points on individual 18 relative to a reference point. Typically, but not necessarily, the gaze direction is the direction of an eye or a nose of individual 18 relative to appliance 14.

An indication regarding the state of appliance 14 can be provided, for example, using an indication panel 26 that may be mounted on appliance 14, or at any other location. Indication panel 26 can be of any type known in the art, such as a set of light emitting diodes (LEDs), a Liquid Crystal Display (LCD), and the like.

In various exemplary embodiments of the invention gesture recognition system is configured for determining presence or absence of an individual in scene 20. This can be done for example, by analyzing the image data to identify motion in scene 20, wherein positive identification of motion indicates the existence of an individual in scene 20. Alternatively or additionally, processor 22 can employ computer vision techniques for identifying presence of human in scene 20. Suitable techniques for determining the presence or absence of individuals are described in “Tracking motion objects in infrared videos” Latecki, L. J, et. al. in IEEE conference on Advance Video and Signal Based Surveillance, 2005, the contents of which are hereby incorporated by reference.

Determining presence or absence of an individual in the scene is advantageous since it allows system 10 to significantly reduce the power consumption. For example, in some embodiments of the present invention, processor 22 signals controller 24 to change the power consumption level of appliance 14 based on the presence or absence of an individual at the vicinity of the appliance. As a representative example, appliance 14 can be switched to a standby mode or be powered off or operate at reduced power consumption when processor 22 identifies that no human is at the vicinity of the appliance. This embodiment is particularly useful for highly power consuming appliances such as air-conditioning and lighting systems.

In some embodiments of the present invention the power consumption level of gesture recognition system 12 is changed based on presence or absence of an individual at the vicinity of system 12. Typically, when no individual is identified in the scene, system 12 operates at low wattage (e.g., at power of less than 10 watts, or less that 5 watts or less than 2 watts or less than 1 watt). This can be achieved by providing one or more of imaging devices with a pixilated sensor, and activating and deactivating some of the pixels responsively to the presence or absence of individual in the vicinity of system 12. For example, one or more of devices 16 can include a Complementary Metal Oxide Semiconductor (CMOS) image sensor having a matrix arrangement of pixels connected to two or more separate local Image Signal Processors (ISPs), e.g., through a Bus. A first ISP can uses only a portion (e.g., less than 50% or less than 25% or less than 10%) of the pixel matrix, and a second ISP can be use all the pixels of the matrix. Since the first ISP uses only a portion of the pixels its power consumption is low. In contrast the second ISP is preferably a full performance ISP. A representative example of an image sensor that can be used according to some embodiments of the present invention is provided in the Examples section that follows.

The power consumption of system 12 can be controlled also by varying other parameters of devices 16. For example, in some embodiments of the present invention when no individual is identified in the scene, system 12 reduced frame rate (e.g., less than 50% of the nominal frame rate of devices 16), and when individual 18 is identified in the scene, system 12 operates at higher frame rate (e.g., at least 90% of the nominal frame rate of devices 16).

In various exemplary embodiments of the invention system 12 is maintained operative at all times, albeit not at constant power consumption. When no individual is identified in the scene, system 12 preferably operate at power consumption of at least 1% and less than 10%, and when an individual is identified in the scene, system 12 preferably operate at power consumption of at least 90%. In some embodiments the power consumption of system 12 is adaptive the ambient lighting conditions. For example, at bright light condition (e.g., above 10,000 1×, for example, during daytime, either in an outdoor environment, or in an indoor environment that receives sufficient amount of sunlight) the system can operate at lower power consumption, than at low light condition (e.g., below 10,000 1×). This allows further reduction of the power consumption while maintaining relatively high accuracy.

The present embodiments also contemplate selective and/or conditional remote controlling. For example, system 12 can apply an object identification procedure for identifying individual 18, wherein the change of state of appliance 14 is conditional to positive identification of individual 18. Specifically, when system 12 is employed in a conditional mode, identification features of one or more authorized individuals are stored in the memory (not shown) of processor 22, so as to exclusively allow the authorized individuals to remote control appliance 14. In use, system 12 executes the object identification procedure and determines, based on the previously stored identification features, whether or not the individual in the scene (if present) is an authorized individual. If the individual is authorized, controller 24 sends operation commands to appliance 14 responsively to recognized gestures made by the authorized individual. If there is no positive identification of the individual, processor 22 determines that the individual is not authorized, and controller 24 does not send operation commands to appliance 14 even if the individual attempts to make recognized gestures.

A representative object identification procedure suitable for the present embodiments is a face recognition procedure, optionally and preferably based on three-dimensional imaging. Such procedures are known in the art and found, for example, in “Large-scale pose-invariant face recognition using cellular simultaneous recurrent network” Yong Ren et al. Applied Optics, Vol. 49, Issue 10, pp. B92-B103 (2010).

In some embodiments of the present invention system 12 selects the appliance to be controlled from a plurality of appliances. This is optionally and preferably performed based on one or more of the recognized gestures. For example, prior to a gesture that is intended to control a particular appliance, individual 18 can use his or hers index finger to point at the appliance. System 12 can recognize this gesture as a command to select the particular appliance, and waits for individual 18 to make an additional gesture. Once the additional gesture is made, system 12 recognizes it and operates the selected appliance as further detailed hereinabove. In various exemplary embodiments of the invention system 12 turn the respective appliance automatically once the appliance is selected.

An additional example of a gesture that can be used for selecting an appliance is a gaze gesture. In this embodiment, system 12 selects a particular appliance if the gaze of individual 18 is directed to the particular appliance for a time period which is above a predetermined threshold. A typical value for the predetermined threshold is several (e.g., 3) seconds.

Once system 12 selects the appliance to be controlled, an indication can be provided to allow the individual to verify that his or hers next gesture will control the desired appliance. Such indication can be provided by indication panel 26. When indication panel 26 is mounted on or near the appliance, the indication can be a simple change in LED color. When indication panel 26 is mounted away from the appliance, the indication can include a text message or a graphical symbol (e.g., an icon) indication which of the appliance will be controlled by the next gesture.

An additional example of a criterion that can be used for selecting an appliance relates to voice recognition. In these embodiments system 12 comprises a voice recognition system 28 configured for selecting an appliance from a plurality of appliances based on voice input from individual 18. Voice recognition systems are known per se, and can include systems that recognize spoken words and optionally also voice imprint to identify the individual that has spoken. A voice recognition system suitable for the present embodiments, is marketed by Rubidium, Raanana 43000, Israel.

An additional example for a procedure suitable for selecting an appliance relates to the use of an active pointer, such as a laser pointer that marks the appliance to be controlled by projecting an illumination pattern on the appliance. In these embodiments, the appliances are within the field-of-view of at least one of the imaging devices 16. Processor 22 can process the images to identify the illumination pattern, and to select the illuminated appliance.

The present embodiments also contemplate embodiments in which the same gesture is used both for selecting the appliance and for controlling it. In these embodiments at least one state of at least one of the appliance is associated with a unique gesture, wherein no other state of any of the appliances is associated with that unique gesture. When system 12 recognizes such a unique gesture, controller 24 signals the corresponding command to the appropriate appliance.

The present embodiments also contemplate embodiments in which more than one appliance is controlled generally simultaneously (e.g., within a few seconds or within less than a second). When system 12 recognizes a gesture that is associated with general simultaneous operation of two or more appliances, controller 24 signals the respective commands to those appliances. A particular example of these embodiments is a global mute command that reduces the audio level of all the appliances that have audio output functionality to zero. A gesture that can be associated with a global mute command can be, for example, an index finger that is placed on the lips of the individual.

Following is a more detailed description of system 12, according to some embodiments of the present invention.

One or more of the imaging devices 16 of system 12 is optionally and preferably configured for providing a stream of image data. The stream represents a series of frames or a series of batches of frames captured at a rate which is selected so as to provide sufficient information to allow spatial as well as time-dependent inspection or analysis. The series of frames or batches of frames collectively referred to as “image.” For example, the stream of image data can form a video image.

In various exemplary embodiments of the invention at least one of the imaging devices is configured to provide a field-of-view of scene 20 or a part thereof over a spectral range from infrared to visible light. Preferably, at least one, more preferably, all the imaging devices comprise a pixelated imager, such as, but not limited to, a CCD or CMOS matrix, which is devoid of IR CUT filter and which therefore generates a signal in response to light at any wavelength within the visible range and any wavelength within the IR range, more preferably the near IR range.

When the imaging devices comprise pixelated imagers, such as a CCD or CMOS imagers, a color filter array is preferably employed in each imager, so as to allow to separately detect photons of different visible wavelength ranges, typically, but not necessarily, to separately detect red photons, green photons and blue photons. Also contemplated, are embodiments in which the imaging device comprises 3 or more separated imager, each being overplayed by a filter of different color (known as 3CCD configuration).

The color filter array is preferably placed in front of the pixels so that each pixel measures the light of the color of its associated filter. For example, in various exemplary embodiments of the invention each pixel of the imager is covered with either a red, green or blue filter, according to a specific pattern, to respectively acquire spectrum information of long, medium, and short wavelengths. In some embodiments of the present invention the imager has at least one pixel that is not covered by any colored filter (RGBW) or covered with IR filter or with a different color then RGB (e.g., Cyan or Orange).

A preferred color filter array is a Bayer filter disclosed in U.S. Pat. No. 3,971,065, the contents of which are hereby incorporated by reference. A Bayer filter is designed to be analogous to the cones of the human visual system, and has red, green, and blue color filter elements (typically, but not necessarily, micro lense elements) superimposed on the pixels of the imager. The Bayer filter array samples the green information on a quincunx grid and the red and the blue information on a rectangular grid.

While the embodiments above are described with a particular emphasis to Bayer filter, it is to be understood that more detailed reference to Bayer filter is not to be interpreted as limiting the scope of the invention in any way, and that other color filter arrays are not excluded from the scope of the present invention.

The missing color information of the colors that are filtered out of an individual pixel can be interpolated by a process known as “demosaicing” using the color values of neighboring pixels. When the imaging devices have electronic-calculation functionality, the demosaicing process for each imaging device can be performed, partially or completely by the respective imaging device. The demosaicing process can alternatively be performed by processor 22, using a program of instructions executable by processor 22 to perform the demosaicing process.

The imaging devices optionally and preferably have electronic calculation functionality, such as an associated processor, that allows it to automatically perform various operations before, during or after image capture. Representative examples of at least some of these operations including, without limitation, Automatic Exposure Control (AEC), Automatic White Balancing (AWB) and the like. Typically, the imaging device also performs at least one operation selected from the group consisting of Automatic Gain Control (AGC) and Automatic Black Level Control (ABLC).

In AEC, the imaging device automatically selects the exposure time based on the lighting condition, without user intervention. For given light conditions and lens aperture, there is an optimum exposure time that produces desirable pictures. An exposure time longer than optimum results in an image that is overly bright (Saturated), and it will look washed out. An exposure time shorter than the optimum time results in an image that is too dark (noisy) and difficult to view.

For achieving AEC, the associated processor can perform a histogram analysis on a signal strength measured at all the locations in a picture using multiple preliminary frames. In some embodiments, the actual frame mean is determined and compared with a desired frame mean. If the actual frame mean is less than the desired mean, then the exposure time is increased; otherwise, the exposure time is decreased. In some embodiments, all the pixels within some region-of-interest are sorted into different brackets depending on their brightness. The number of pixels that are unacceptably bright and the number of pixels that are unacceptably dark are counted. An incremental adjustment to the exposure setting is applied so as to balance the number of pixels that are too dark with those that are too bright.

In AWB the associated processor multiplies the individual colors (e.g., red, green and blue colors, when an RGB color system is employed) by certain coefficients, known as white balance WB parameters. Since pixels of different colors generally have different light sensitivity, they oftentimes produce different signal levels even if incident light is white (for example, light having equal components of red, green and blue). As a result, a white object in the scene does not appear white without further processing. The use of WB parameters allows to artificially adjust the levels of pixels of different colors so that the image of a white object appears white in a picture.

For achieving AGC, the imaging device includes an AGC circuit that processes the analog video from the imager to scale the analog signal before the signal is digitized. Typically, the AGC circuit receives an analog voltage from the imager and generates a temperature compensated gain voltage.

ABLC (also known as Automatic Black Level Calibration) can be executed by the imaging device using an analog circuit which processes the signal from the imager before it is being digitized and/or an associated processor which performs digital signal processing. Generally, the imaging device sets a threshold, also known as the black level set point, that is slightly greater than the read noise. In some embodiments of the present invention the imaging device calibrates the black level for every field using extra pixel rows that are shielded from incident light.

All the above automatic operations are known to those skilled in the art of digital imaging and are already implemented in many types of pixelated imagers.

Representative examples of a characteristic wavelength range detectable by the imaging devices include, without limitation, any wavelength from about 400 nm to about 1100 nm, or any wavelength from about 400 nm to about 1000 nm. In some embodiments of the present invention the imaging devices also provide signal responsively to light at the ultraviolet (UV) range. In these embodiments, the characteristic wavelength range detectable by the imaging devices can be from about 300 nm to about 1100 nm. Other characteristic wavelength ranges are not excluded from the scope of the present invention.

In some embodiments of the invention when system 12 is in a low power consumption mode (e.g., when no individual is present in the scene), only infrared detection is employed by devices 16. The overall power consumption of system 12 in this mode is optionally and preferably at least 1% and less than 10% of the maximal power consumption of system 12. When system 12 is in normal power consumption mode (e.g., when the scene is occupied by at least one individual), visible light detection is employed by devices 16. The overall power consumption of system 12 in this mode is optionally and preferably at least 90% of the maximal consumption. Optionally, infrared detection is employed both in low power consumption mode and in normal power consumption mode.

Imaging devices 16 are optionally and preferably configured for capturing image data that includes range data.

The range data describe topographical information of the remote user or remote scene and is optionally and preferably received in the form of a depth map.

The term “depth map,” as used herein, refers to a representation of a scene as a two-dimensional matrix, in which each matrix element corresponds to a respective location in the scene and has a respective matrix element value indicative of the distance from a certain reference location to the respective scene location. The reference location is typically static and the same for all matrix elements. A depth map optionally and preferably has the form of an image in which the pixel values indicate depth information. By way of example, an 8-bit grey-scale image can be used to represent depth information. The depth map can provide depth information on a per-pixel basis of the image data, but may also use a coarser granularity, such as a lower resolution depth map wherein each matrix element value provides depth information for a group of pixels of the image data.

The range data can also be provided in the form of a disparity map. A disparity map refers to the apparent shift of objects or parts of objects in a scene (the remote scene, in the present example) when observed from two different viewpoints, such as from the left-eye and the right-eye viewpoint. Disparity map and depth map are related and can be mapped onto one another provided the geometry of the respective viewpoints of the disparity map are known, as is commonly known to those skilled in the art.

In order to improve the quality of the reconstructed three-dimensional image, additional occlusion information, known in the art as de-occlusion information, can be provided. (De-)occlusion information relates to image and/or depth information which can be used to represent views for additional viewpoints (e.g., other than those used for generating the disparity map). In addition to the information that was occluded by objects, the occlusion information may also comprise information in the vicinity of occluded regions. The availability of occlusion information enables filling in of holes which occur when reconstructing the three-dimensional image using a 2D+range data.

In some embodiments of the present invention imaging system 12 is configured for capturing stereoscopic image data, for example, by capturing scene 20 from two or more different view points. From the stereoscopic image data, data processor 22 optionally and preferably calculates range data. The calculated range data can be in the form of a depth map and/or a disparity map, as further detailed hereinabove. Optionally, data processor also calculates occlusion data. In some embodiments, system 12 capture scene 20 from three or more viewpoints so as to allow data processor to calculate the occlusion data in higher precision.

In some embodiments of the present invention system 12 comprises one or more light sources 30 configured to illuminate scene 20, particularly individual 18, by visible, infrared or ultraviolet light so as to allow processor 12 or imaging system 24 to calculate the range data using a time-of-flight (TOF) technique. In these embodiments, the light source is configured for emitting light with intensity that varies with time.

The TOF technique can be employed, for example, using a phase-shift technique or pulse technique.

With the phase-shift technique, the amplitude of the emitted light is periodically modulated (e.g., by sinusoidal modulation) and the phase of the modulation at emission is compared to the phase of the modulation at reception. The modulation period is optionally and preferably in the order of twice the difference between the maximum measurement distance and the minimum measurement distance divided by the velocity of light, and the propagation time interval can be determined as phase difference.

With the pulse technique, light is emitted in discrete pulses without the requirement of periodicity. For each emitted pulse of light the time elapsed for the reflection to return is measured, and the range calculated as one-half the product of round-trip time and the velocity of the signal.

In some embodiments, processor 22 calculates the range data based on a triangulation technique, such as, but not limited to, a structured light technique. In these embodiments, the light source 30 projects a light pattern in the visible, infrared or ultraviolet range onto scene 20, particularly individual 18. An image of the reflected light pattern is captured by an imaging device and the range data are calculated by processor 22 based on the spacings and/or distortions associated with the reflected light pattern relative to the projected light pattern. Preferably, the light pattern is invisible to the naked eye (e.g., in the infrared or ultraviolet range). Representative examples of patterns suitable for calculating of range data using the structured light technique including, without limitation, a single dot, a single line, and two-dimensional pattern (e.g., horizontal and vertical lines, checkerboard pattern, etc.). The light from the light source 30 can scan individual 18 and the process is repeated for each of a plurality projection directions.

Additional techniques for calculating range data suitable for the present embodiments are described in, e.g., S. Inokuchi, K. Sato, and F. Matsuda, “Range imaging system for 3D object recognition”, in Proceedings of the International Conference on Pattern Recognition, pages 806-808, 1984; U.S. Pat. Nos. 4,488,172, 4,979,815, 5,110,203, 5,703,677, 5,838,428, 6,349,174, 6,421,132, 6,456,793, 6,507,706, 6,584,283, 6,823,076, 6,856,382, 6,925,195 and 7,194,112; and International Publication No. WO 2007/043036, the contents of which are hereby incorporated by reference.

When the image data includes range data, processor 22 reconstructs a three-dimensional image of individual 18 from the image data. This three-dimensional image is useful because it allows processor 22 to determine the gesture made by individual in greater accuracy than using two-dimensional image.

The three-dimensional image comprises geometric properties of a non-planar surface which at least partially encloses a three-dimensional volume. Generally, the non-planar surface is a two-dimensional object embedded in a three-dimensional space.

Formally, a non-planar surface is a metric space induced by a smooth connected and compact Riemannian 2-manifold. Ideally, the geometric properties of the non-planar surface would be provided explicitly for example, the slope and curvature (or even other spatial derivatives or combinations thereof) for every point of the non-planar surface. Yet, such information is rarely attainable and the spatial information of the three-dimensional image is provided for a sampled version of the non-planar surface, which is a set of points on the Riemannian 2-manifold and which is sufficient for describing the topology of the 2-manifold. Typically, the spatial information of the non-planar surface is a reduced version of a 3D spatial representation, which may be either a point-cloud or a 3D reconstruction (e.g., a polygonal mesh or a curvilinear mesh) based on the point cloud. The 3D image is expressed via a 3D coordinate system, such as, but not limited to, Cartesian, Spherical, Ellipsoidal, 3D Parabolic or Paraboloidal coordinate 3D system.

It is appreciated that a three-dimensional image of an object is typically a two-dimensional image which, in addition to indicating the lateral extent of object members, further indicates the relative or absolute distance of the object members, or portions thereof, from some reference point, such as the location of the imaging device. Thus, a three-dimensional image typically includes information residing on a non-planar surface of a three-dimensional body and not necessarily in the bulk. Yet, it is commonly acceptable to refer to such image as “three-dimensional” because the non-planar surface is conveniently defined over a three-dimensional system of coordinate. Thus, throughout this specification and in the claims section that follows, the term “three-dimensional image” primarily relate to surface entities.

The reconstruction of three-dimensional image using the image and range data and optionally also occlusion data can be done using any procedure known in the art. Representative examples of suitable algorithms are found in Qingxiong Yang, “Spatial-Depth Super Resolution for Range Images,” IEEE Conference on Computer Vision and Pattern Recognition, 2007, pages 1-8; H. Hirschmuller, “Stereo Processing by Semiglobal Matching and Mutual Information,” IEEE Transactions on Pattern Analysis and Machine Intelligence, 2008, 30(2):328-341; International Publication No. WO1999/006956; European Publication Nos. EP1612733 and EP2570079; U.S. Published Application Nos. 20120183238 and 20120306876; and U.S. Pat. Nos. 7,583,777 and 8,249,334, the contents of which are hereby incorporated by reference.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find support in the following examples.

### EXAMPLES

Reference is now made to the following examples, which together with the above descriptions illustrate some embodiments of the invention in a non limiting fashion.

At least one of imaging devices 16 of system 12 preferably includes a CMOS imager capable of detecting both visible light and near infrared (NIR). The imager is in the form of a chip which comprises a matrix arrangement of pixels connected to one or more (e.g., two) ISP's through a Bus. A first ISP is optionally and preferably a very low power ISP which uses only a small part of the pixel matrix, and a second ISP is optionally and preferably a full performance ISP. System 12 optionally and preferably also has more than one (e.g., two) separate power connections and an internal power network, a I²C bus interface, optionally several GPIO connections, and optionally at least two LED outputs for three different modes that may indicate the current system mode for the user.

In some embodiments of the present invention the two sets of pixels are identical, except that they are connected differently to the circuit. Alternatively, the pixels in the first set can be different from the pixels in the second set. For example, the pixels in one set can be configured for detecting only IR light and the pixels in the second set can be configured for detecting only visible light or both IR light and visible light.

According to some embodiments of the present invention system 12 has three separate modes.

A first mode is referred to as a standby mode. In this mode system 12 operates at low power consumption. Preferably, only IR detection is employed in this mode. The first mode is typically employed when no individual is present in the scene.

A second mode is referred to as a switching mode. In this mode system 12 alternates between a low power mode and normal power mode. Preferably, both IR detection and visible light detection is employed in this mode. The second mode is typically employed when an individual is present in the scene, but before a gesture of the individual has been detected or identified.

A third mode is referred to below as an active mode. In this mode, system 12 operates in normal power consumption. Preferably, only visible light detection is employed in this mode.

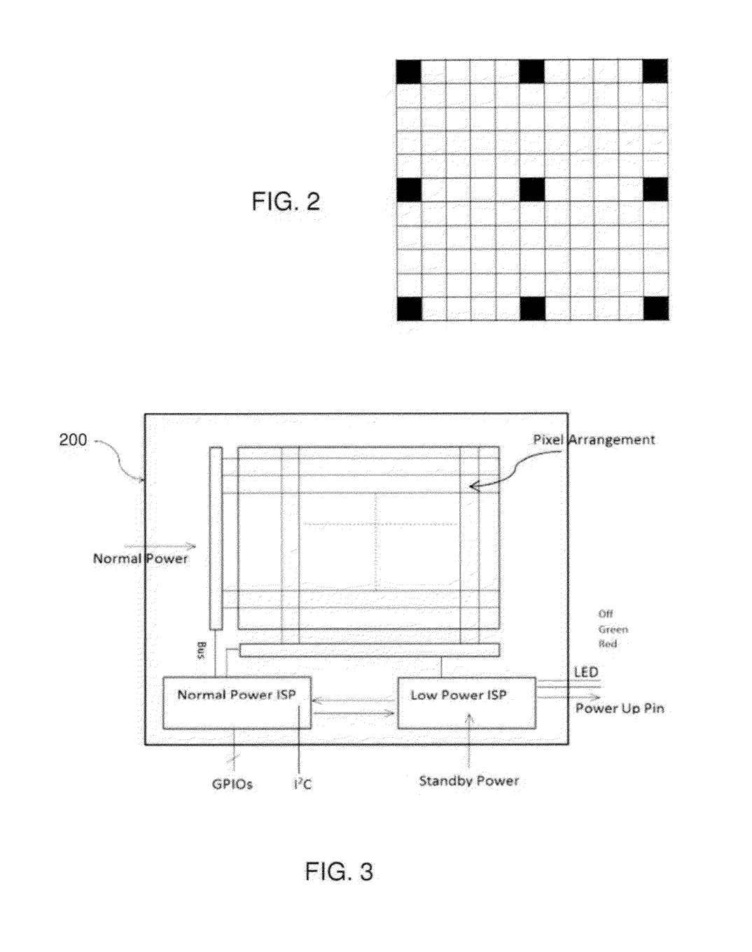

A representative example of an arrangement of the pixels on the sensor of the present embodiments is illustrated in FIG. 2. The arrangement includes two sets of pixels: a first set (shown in black) that is used according to some embodiments of the present invention in the standby mode, and a second set (shown in white) that is used, according to some embodiments of the present invention, in the third mode. The pixels of the first set are optionally and preferably distributed such that they share the same optical focal point with the pixels of the second set.

In some embodiments of the present invention the frame rate of the imaging devices 16 is also selected based on the operation mode as further detailed hereinabove.

In some embodiments of the present invention system 12 automatically selects the standby mode when there is no human presence in the scene.

FIG. 3 is a schematic illustration of an imaging sensor 200 that is employed by imaging device 16, according to some embodiments of the present invention. In the present example, all pixels are connected to the bus. The bus is optionally and preferably connected to a Normal Power ISP as well as to a Low Power ISP. The two ISPs are connected with power connections as known in the art. An I²C bus and a GPIO connect the Normal ISP to the appliance. A Power-Up pin can optionally and preferably connect the sensor to the appliance to allow it to turn the on the appliance.

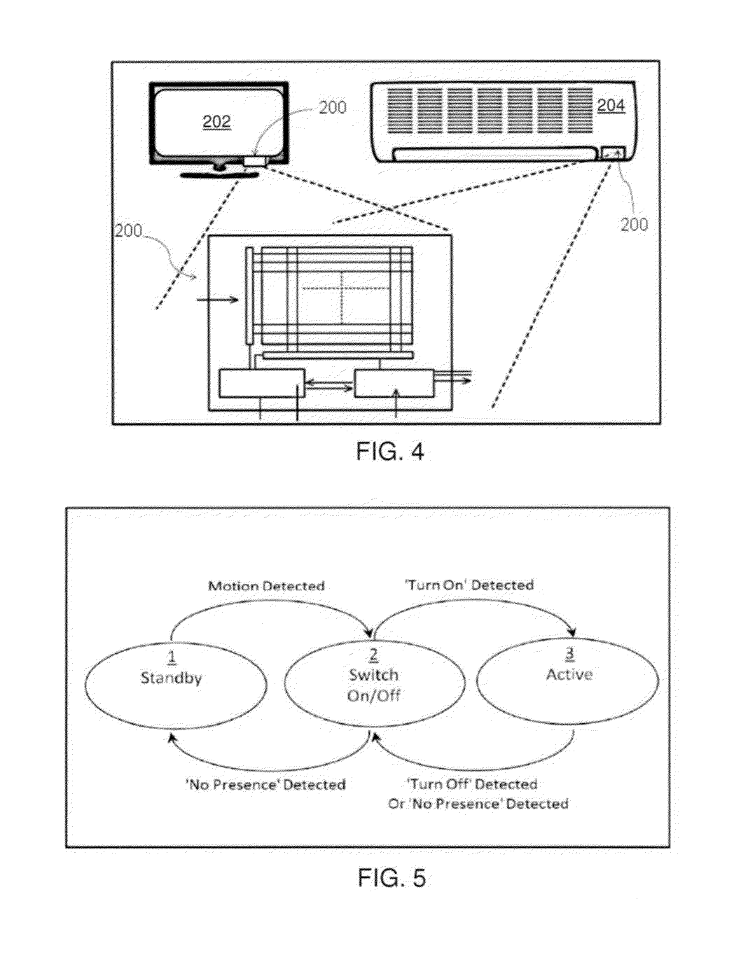

FIG. 4 is a schematic illustration of the relation between sensor 200 and several home appliances, according to some embodiments of the present invention. Shown in FIG. 4 are two appliance (a television system 202 and an air-condition system 204 in the present example), each mounted with an imaging sensor 200.

FIG. 5 is a schematic illustration describing an operation protocol of sensor 200, according to some embodiments of the present invention. As illustrated, upon detection of presence of an individual in the scene (e.g., by detecting motion in the scene) the sensor selects the second mode, and when a gesture is recognized (e.g., a gesture corresponding to a “turn on” command) the sensor selects the third mode. Conversely, when a gesture corresponding to a “turn off” command is recognized, the second mode is selected, and when no individual is present in the scene the first mode is selected.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of remote controlling, comprising:
using a gesture recognition system for capturing image data from a scene at the vicinity of an appliance and processing said image data to recognize at least one gesture of an individual present in said scene; and
changing a state of said appliance based on said at least one recognized gesture.

2. The method of claim 1, further comprising determining presence or absence of said individual in said scene.

3. The method of claim 2, further comprising changing a power consumption level of said appliance based on said presence or absence.

4. The method according to claim 2, further comprising changing a power consumption level of said gesture recognition system based on said presence or absence.

5. The method of claim 4, wherein said gesture recognition system comprises a plurality of pixilated sensors, and wherein said changing said power consumption level of said gesture recognition system comprises activating and deactivating pixels of said pixilated sensors responsively to said presence or absence.

6. The method according to claim 1, further comprising identifying said individual, wherein said changing said state is conditional to positive identification of said individual.

7. (canceled)

8. The method according to claim 1, further comprising selecting said appliance from a plurality of appliances based on said at least one recognized gesture.

9. (canceled)

10. The method according to claim 8, wherein said appliance is selected if a gaze of said individual is directed to said appliance for a predetermined time period.

11. (canceled)

12. The method according to claim 8, wherein said appliance is selected based on voice input from said individual.

13. The method according to claim 1, further comprising selecting said appliance from a plurality of appliances based on an illumination pattern projected on said appliance.

14. (canceled)

15. The method according to claim 1, wherein said recognizing said at least one gesture comprises analyzing a three-dimensional image of said individual.

16. (canceled)

17. The method according to claim 1, wherein said recognizing said at least one gesture comprises analyzing an infrared image of said individual.

18. (canceled)

19. A remote control system, comprising:
a gesture recognition system configured for capturing image data from a scene at the vicinity of an appliance, and processing said image data to recognize at least one gesture of an individual present in said scene; and
a controller configured for changing a state of said appliance based on said at least one recognized gesture.

20. The system of claim 19, wherein said gesture recognition system is configured for determining presence or absence of said individual in said scene.

21. The system of claim 20, wherein said gesture recognition system is configured for changing a power consumption level of said appliance based on said presence or absence.

22. The system according to claim 20, wherein said gesture recognition system is configured for changing a power consumption level of said gesture recognition system based on said presence or absence.

23. The system of claim 22, wherein said gesture recognition system comprises a plurality of pixilated sensors, and being configured to activate and deactivate pixels of said pixilated sensors responsively to said presence or absence.

24. The system according to claim 19, wherein said gesture recognition system is configured for identifying said individual, wherein said changing said state is conditional to positive identification of said individual.

25. The system according to claim 19, wherein said gesture recognition system is configured for selecting said appliance from a plurality of appliances based on said at least one recognized gesture.

26. The system according to claim 25, wherein said appliance is selected if a gaze of said individual is directed to said appliance for a predetermined time period.

27. The system according to claim 19, wherein said gesture recognition system comprises a voice recognition system configured for selecting said appliance from a plurality of appliances based on voice input from said individual.

28. The system according to claim 19, wherein said gesture recognition system is configured for selecting said appliance from a plurality of appliances based on an illumination pattern projected on said appliance.

29. The system according to claim 19, wherein said gesture recognition system is configured for capturing and analyzing a three-dimensional image of said individual.

30. The system according to claim 19, wherein said gesture recognition system is configured for capturing and analyzing an infrared image of said individual.
